(19) United States
(12) Patent Application Publication
(10) Pub. No.: US 2011/0158309 A1
(43) Pub. Date: Jun. 30, 2011

(54) METHOD AND APPARATUS FOR DETERMINING REPRODUCTION ACCURACY OF DECOMPRESSED VIDEO

(75) Inventors: TYRONE D. BEKIARES, CHICAGO, IL (US); FAISAL ISHTIAQ, CHICAGO, IL (US); STEVEN D. TINE, BUFFALO GROVE, IL (US)

(73) Assignee: MOTOROLA, INC., SCHAUMBURG, IL (US)

(21) Appl. No.: 12/648,274

(22) Filed: Dec. 28, 2009

(51) Int. Cl. H04N 11/04

(52) U.S. Cl. 375/240.01; 375/E07.001

(57) ABSTRACT

A video decoder receives compressed video and processes the video to generate decompressed video comprising a plurality of pixels in a sequence of frames. For at least some of the pixels, the video decoder further determines, on a pixel by pixel basis, motion vector and quantizer values used to perform compression of the pixels and determines a quality value for each corresponding pixel using the motion vector and quantizer values, wherein the quality value provide a measure of reproduction accuracy of the decompressed video with respect to corresponding uncompressed video.

### TECHNICAL FIELD

The technical field relates generally to video compression and more particularly determining accuracy of decompressed video with respect to corresponding uncompressed video.

### BACKGROUND

Modern video codecs employ two basic techniques for encoding source video: spatial compression and temporal compression. In either case, the source video is first divided into a mesh of macroblocks. Some or all of the macroblocks may be “spatially encoded” (i.e., Intra encoded or “I”), whereby a transform, typically a Discrete Cosine Transform (DCT), is performed over the spatial data, and the resulting coefficients are quantized. Lower quantizer values (Q) result in a highly accurate decoded reconstruction of the macroblock data, while higher Q values result in a relatively poor reconstruction.

Likewise, some or all of the macroblocks may be “temporally encoded” (i.e. Inter encoded or Predictive or “P”); and in this case, a “motion vector (MV)” is estimated which represents magnitude and direction of the spatial data contained in a macroblock over time. Residual spatial data which is not properly reconstructed through motion compensation may also be encoded spatially as a difference to the motion compensated reconstruction. The accuracy of temporal encoding is driven by a multitude of factors, e.g., tools available for describing the motion vectors, complexity of the motion estimation algorithm, and the quantizer value used for encoding any residual spatial data.

Existing video decoders present reconstructed (decompressed) video in a manner that seamlessly interleaves the above compression techniques, and the reconstructed accuracy of any given cluster of pixels may vary widely across the decompressed image. While this seamless presentation of data may be advantageous for consumer applications, it is potentially misleading for other applications, such as public safety applications.

For example, for public safety officials making real-time tactical decisions based on decompressed video, such ambiguity in accuracy of representation may be unacceptable. This distinction is even more important when the decompressed video is used for forensic or evidentiary purposes. For instance, if a given macroblock is spatially encoded using a high quantizer value, it may obscure small, but critical objects, such as the presence of a gun. Ultimately, public safety operators need a means by which to estimate, optionally in real-time, a given pixel's representation accuracy with respect to the uncompressed pixel it encoded.

Determining pixel-based reproduction accuracy is achievable through a variety of full-reference video quality metrics, e.g. peak signal-to-noise ratio (PSNR), vector quality measurement (VQM). As the phrase “full-reference” implies, such metrics require simultaneous access to both the source (uncompressed) and decompressed video frames. However, outside of the laboratory, source video is typically not available after it has been encoded; this is because the video is usually too large to store and/or transmit uncompressed (hence the reason it was compressed in the first place). For this reason and because these algorithms are somewhat processor intensive, they don't typically run in real-time.

Thus, there exists a need for a method and apparatus for determining the accuracy of decompressed video with respect to the corresponding uncompressed video when the uncompressed video is unavailable.

### BRIEF DESCRIPTION OF THE FIGURES

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 is a block diagram of a video processing system that determines the reproduction accuracy of decompressed video with respect to the corresponding source video in accordance with some embodiments.

FIG. 2 is a flow diagram illustrating a method for determining the reproduction accuracy of decompressed video with respect to the corresponding source video in accordance with some embodiments.

FIG. 3 is a flow diagram of a method for determining relative quality values for pixels in decompressed video.

FIG. 4 is a flow diagram illustrating a method for ranking the relative quality values for pixels in decompressed video.

FIG. 5 illustrates determining relative quality values for a first frame in a sequence of frames of decompressed video.

FIG. 6 illustrates determining relative quality values for a subsequent frame in the sequence of frames of decompressed video.

FIG. 7 illustrates determining relative quality values for yet a subsequent frame in the sequence of frames of decompressed video.

FIG. 8 illustrates a flow diagram of a method for determining absolute quality values for pixels in decompressed video.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION

Generally speaking, pursuant to the various embodiments, a video decoder receives compressed video and processes the video to generate decompressed video comprising a plurality of pixels in a sequence of frames. For at least some of the pixels, the video decoder further determines, on a pixel by pixel basis, motion vector and quantizer values used to perform compression of the pixels and determines a quality value for each corresponding pixel using the motion vector and quantizer values, wherein the quality value provide a measure of reproduction accuracy of the decompressed video with respect to corresponding uncompressed video.

Embodiments of the disclosure use a “no-reference” technique (i.e., a technique that does not require or use the uncompressed video) to analyze state and data, already kept by an error resilient video decoder, to produce a matrix of relative and absolute “accuracy” values for pixels in decompressed video. This matrix can be used by public safety, for instance, to assess in real or non-real time, the ability of a given pixel to accurately represent the corresponding pixel in the uncompressed video. This data may then be used for tactical decision making and argument in a court of law. Those skilled in the art will realize that the above recognized advantages and other advantages described herein are merely illustrative and are not meant to be a complete rendering of all of the advantages of the various embodiments.

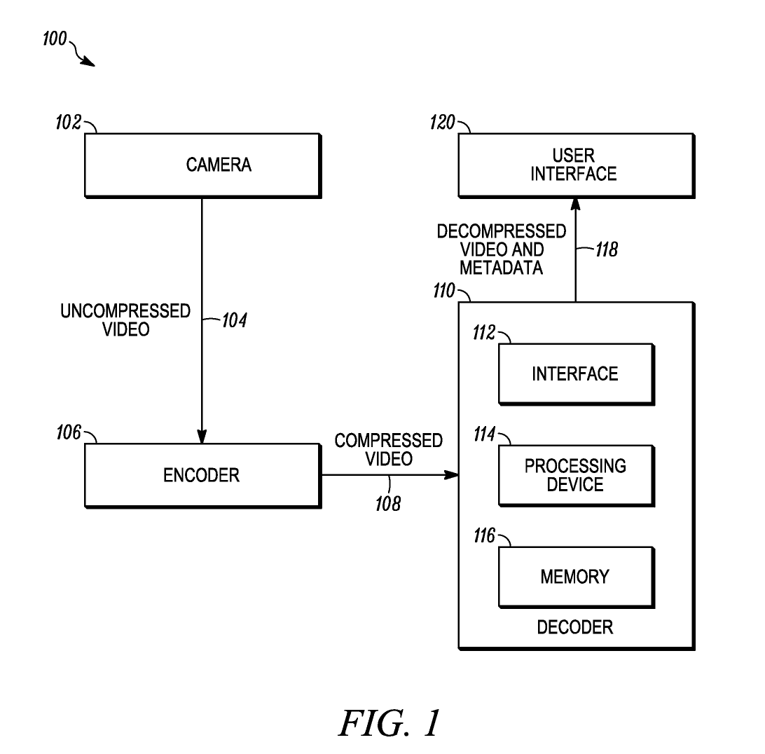

Referring now to the drawings, and in particular FIG. 1, a video processing system that determines the reproduction accuracy of decompressed video with respect to the corresponding uncompressed video in accordance with some embodiments is shown and indicated generally at 100. Video processing system 100 includes a video source 102, and encoder 106, a decoder 110, and a user interface 120.

The video source 102 is illustrated as a video camera but can be any source that provides “uncompressed video” 104, meaning the state of the video as it enters the encoder, which applies spatial and temporal compression; such video in an uncompressed state is described using a bitmap of pixels, and not quantized transforms and motion vectors. “Video”, as the term is used herein, means one or more images comprising a plurality of pixels; wherein when there are a plurality of images, the video is, thereby, a sequence of still images with each image in the video sequence being termed a “frame”. Thus, the video source 102 can alternatively comprise, but is not limited to, a still image camera, a storage medium holding one or more still images, a storage medium holding a sequence of frames, etc.

The encoder 106 can be integrated within the camera 102 or can be a stand alone device that is coupled to the camera 102 using any suitable wired or wireless means. The encoder 106 uses any suitable algorithm for performing spatial and temporal compression of the pixels in the uncompressed video 104 to generate compressed video 108. Examples of such encoding algorithms include, but are not limited to, standard video compression technologies like MPEG-2, MPEG-4, H.263, H.264, etc. Operationally, the encoder divides each frame into a plurality of macroblocks of pixels, which are I encoded or P encoded. The pixels within I encoded macroblocks are termed herein as being “spatially” encoded and are characterized by the quantizer value used to spatially encode the macroblock. P encoded macroblocks include pixels that are termed herein as being “temporally” compensated and are characterized by the MV used to encode the pixel, and may also contain pixels which are spatially encoded as part of a residual encoding.

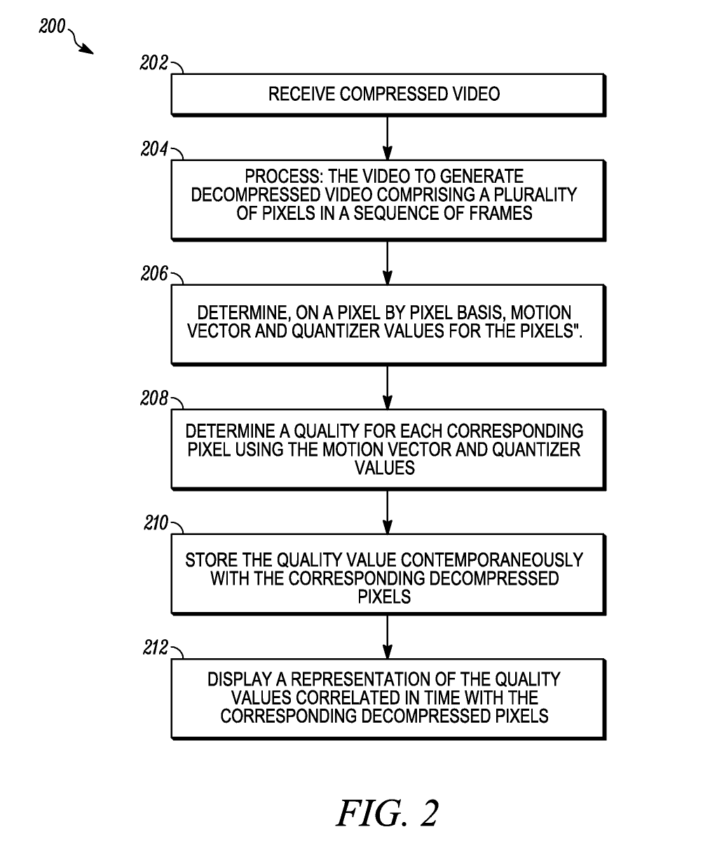

The decoder 110 comprises an interface 112, a processing device 114, and a memory 116 operatively coupled, and which when programmed form the means for the decoder to implement its functionality, which is described in general by reference to FIG. 2. The decoder, in an embodiment, is included within a mobile communication device such as a cellular phone, a personal digital assistant (PDA), a computer, and the like. Upon receiving (202) the compressed video 108 via the interface 112, the processing device 114 processes (204) the compressed video to generate decompressed video comprising a plurality of pixels in a sequence of frames. The processing device 114 further determines (206), for at least some of the pixels on a pixel by pixel basis, motion vector and quantizer values for the pixels and determines (208) an “accuracy” value also termed herein a “quality” value that provides a measure of reproduction accuracy of the decompressed pixel as corresponds to the original un-encoded or uncompressed pixel, in accordance with the disclosed teachings. These accuracy values, which as further described in detail below, are stored (210) in a suitable memory 116 contemporaneously with the corresponding decompressed pixels.

The implementation of the interface 112 of the decoder 110 depends on the particular manner in which the encoder 106 and decoder 110 are coupled, i.e., wired and/or wirelessly, and/or the manner by which the decoder receives the compressed video 108. For example, where the encoder 106 and decoder 110 are coupled via a direct wired connection or the compressed video is downloaded from a memory stick, the interface 112 may comprise a serial port interface (e.g., compliant to the RS-232 standard), a parallel port interface, an Ethernet interface, a USB interface, and/or a FireWire interface, and the like. In other embodiments, the interface may support downloading the compressed video 108 from other types of computer-readable storage media such as CD-ROMs.

Where the encoder 106 and decoder 110 are coupled via a network that supports wireless communications, the interface 112 comprise elements including processing, modulating, and transceiver elements that are operable in accordance with any one or more standard or proprietary wireless interfaces, wherein some of the functionality of the processing, modulating, and transceiver elements may be performed by means of the processor 114 of the decoder through programmed logic such as software applications or firmware stored on the memory 116 of the decoder.

Besides the above-mentioned functionality, implemented via programmed logic or code, the processing device 116 of a decoder is further programmed with logic or code for performing functionality to facilitate methods in accordance with the teachings herein, such as methods described by reference to FIGS. 2 to 8; and/or the processing device 114 may be implemented as a state machine or ASIC. The memory 116 in the decoder 116 can include short-term and/or long-term storage of various data needed for the functioning of the decoder 110 and the accuracy values that it produces. Moreover, although the elements 112, 114, 116 are shown as being included on a single separate hardware platform, these elements can easily comprise a shared hardware platform with at least one mobile communication device and/or a mobile storage device that maintains the accuracy values.

The decompressed video and quality value metadata 118 can also be provided to any suitable user interface 120 such as a display monitor on a mobile communication device that includes the decoder 110 or on any device coupled to the decoder 110 and having a means for visually displaying (212) the video and associated quality data, which are correlated in time.

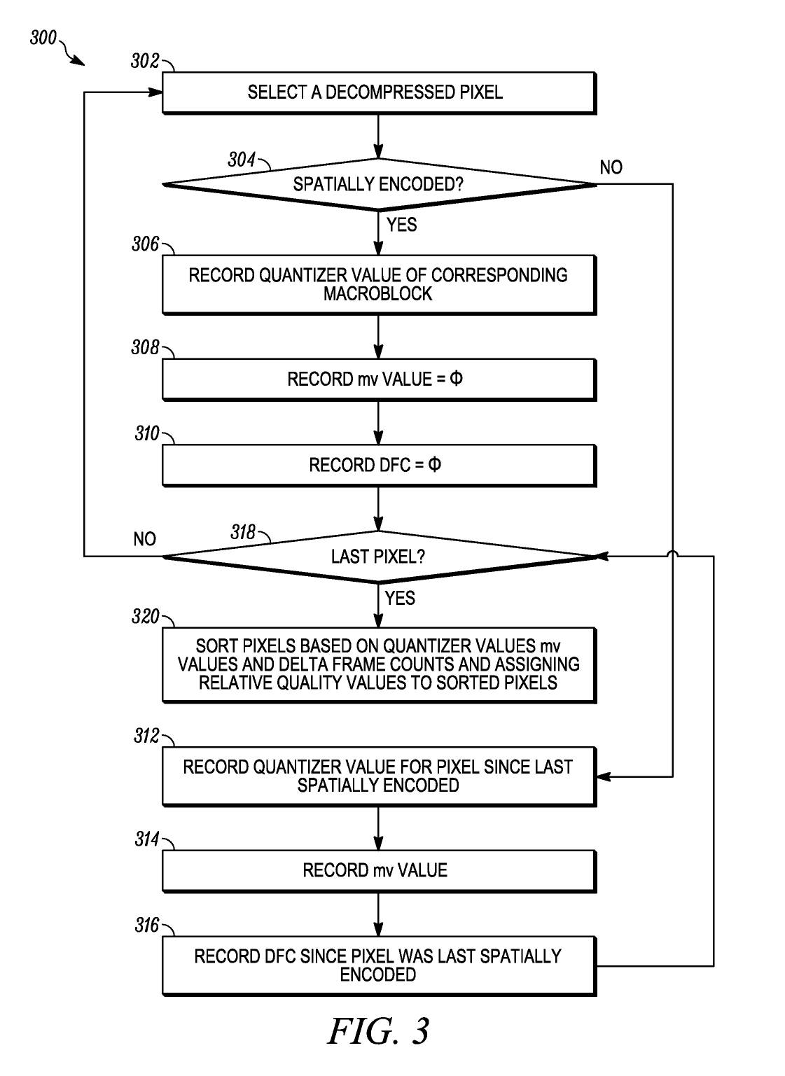

Turning now to a more detailed description of the technique by which the decoder 110 determines the quality values for the decompressed pixels. Embodiments are described for generating “relative” quality values, which means that the quality values of given pixels are determined relative to quality values of other pixels in the same frame and; for generating “absolute” quality values meaning that the quality values of given pixels are determined relative to selected absolute quality value references. FIG. 3 describes a more detailed flow diagram of a method 300, used in a decoder, for determining relative quality values for pixels in decompressed video.

Upon decompressing the video into a sequence of frames broken into a matrix of macroblocks each having a plurality of pixels, the decoder 110 selects (302) a decompressed pixel from a macroblock and determines whether the pixel is spatially encoded or temporally encoded. It should be noted that no particular technique is needed to make the determination 304. One advantage of current error resilient encoder technology, which is leveraged by the present teachings, is the maintaining of certain state information regarding the decoding process. Such state information includes, but is not limited to: whether a pixel was spatially or temporally encoded; if the pixel was spatially encoded, the quantizer value used for the encoding (e.g., the quantizer value used for I encoding the macroblock containing the pixel); if the pixel was temporally compensated, the MV used for the encoding; and a delta frame count (DFC) value corresponding to the number of encoded frames which have elapsed since the pixel was last spatially encoded.

Based on whether the pixel is spatially encoded or temporally compensated, the decoder determines and stores (e.g., in memory 116) a set of values for multiple parameters for the pixel that are later used to determine (320) a relative quality value of the pixel. When the encoder determines (304) that the pixel was spatially encoded, the decoder at a minimum: records (306) the quantizer value of the macroblock that contained the pixel; records (308) a MV value of zero (since the pixel was spatially encoded); and records (310) a DFC of zero since the current pixel was spatially encoded. The decoder can record other data as well such as a time stamp value of the parent frame of the pixel to enable the decoder to later determine the DFC for a temporally encoded pixel in the same pixel location of a subsequent frame.

When the encoder determines (304) that the pixel was temporally compensated, the decoder at a minimum: records (312) the quantizer value for the pixel when spatial encoding was last performed at this pixel location; records (314) a MV magnitude for the pixel; and records (316) the DFC since the pixel was last spatially encoded. Regarding determining the MV for a pixel, in one embodiment, the MV value is computed as the motion vector magnitude value used to encode the pixel only for the current frame. In an alternative embodiment, the decoder may keep track of all motion vector operations performed on a pixel since the last time it was spatially encoded and compute the motion vector value for the current frame as the sum of all the magnitudes of the contributing MVs for that pixel since it was last spatially encoded.

The decoder cycles through functions 302 to 316 in each macroblock of a frame until it reaches and processes (318) the last decompressed pixel of the frame. The decoder then sorts (320) the pixels in the frame based on the corresponding recorded sets of quantizer values, MV values, and DFC values, and assigns relative quality values to the sorted pixels. Process 300 is repeated for each frame of the decompressed video.

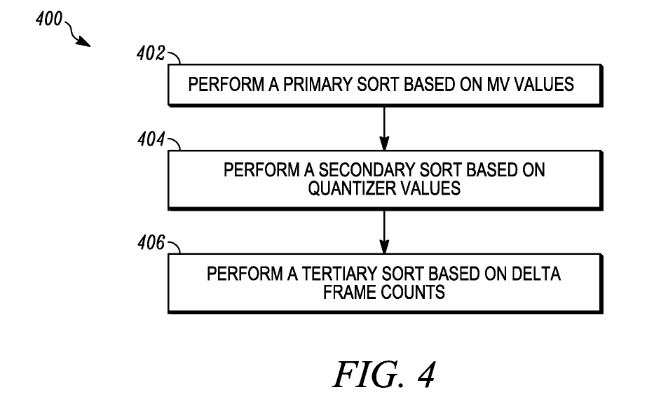

FIG. 4 illustrates an example method 400 for sorting the pixels based on their sets of quantizer values, MV values, and DFC values. Accordingly, the decoder performs (402) a primary sort based on the MV value. The decoder performs (404) a secondary sort based on the quantizer values; and performs (406) a tertiary sort based on the DFC values. In an embodiment, the sorting comprises ranking the pixels based on their sets of quantizer values, MV values, and DFC values, wherein a relative value is assigned to the pixels based on the relative rankings. This sorting process is based on the assumption that motion vectors with large magnitudes have the greatest negative effect on reconstruction accuracy of a given pixel; quantizer values with large magnitudes have the second highest negative effect on reconstruction accuracy of a given pixel; and elapsed encoded frames since spatial refresh has the least highest negative effect on reconstruction accuracy of a given pixel. However, other such sorting algorithms can be accommodated without loss of generality.

The decoder can be programmed with any suitable algorithm for performing the methods 300 and 400 described, respectively, by reference to FIG. 3 and FIG. 4. By way of illustration only, and not to limit the scope of the teachings herein, presented next is an example algorithm used to implement methods 300 and 400 and to determine relative quality values for pixels in a decompressed video stream.

For each pixel “PIX” at coordinates (x,y) in the decoded image:
1. Determine if the parent macroblock of a given pixel PIX(x,y) is intra (I) or inter (P) encoded:
   a. if parent macroblock is intra (I) encoded:
      i. PIX(x,y)=I
   b. if parent macroblock is inter (P) encoded:
      i. if pixel is reconstructed from motion compensation applied to previous pixel value: PIX(x,y)=P
      ii. If pixel is reconstructed from residual spatial encoding applied after a motion compensation operation: PIX(x,y)=I
2. if PIX(x,y)=I:
   a. record effective quantizer value (Q) of parent macroblock as PIX(x,y)[Q]=q
   b. record a zero magnitude motion vector (MV) for the pixel as PIX(x,y)[MV]=0
   c. reset number of frames since pixel was spatially encoded as PIX(x,y)[DFC]=0
3. if PIX(x,y)=P
   a. record the number of frames since pixel was spatially encoded by incrementing PIX(x,y)[DFC] by 1
   b. record effective quantizer value (Q) from the last time pixel was spatially encoded as PIX(x,y)[Q]=PIX(x,y)[Q]
   c. record magnitude of the motion vector (MV) associated with the motion compensated pixel as PIX(x,y)[MV]=mv for the current frame or PIX(x,y)[MV]=PIX(x,y)[MV]+mv, when the MV magnitudes are summed since the pixel was last spatially encoded
4. Sort pixels as follows:
   a. primary sort: low-to-high values of PIX(x,y)[MV]
   b. secondary sort: low-to-high values of PIX(x,y)[Q]
   c. tertiary sort: low-to-high values of PIX(x,y)[DFC]
5. Each PIX(x,y) in the sorted array is now assigned a representation accuracy value PIX(x,y)[RA] from 0 to the number of unique PIX[MV,Q,DFC] combinations in the array. PIX(x,y) with the same PIX[MV,Q,DFC] values should be assigned the same PIX[RA].

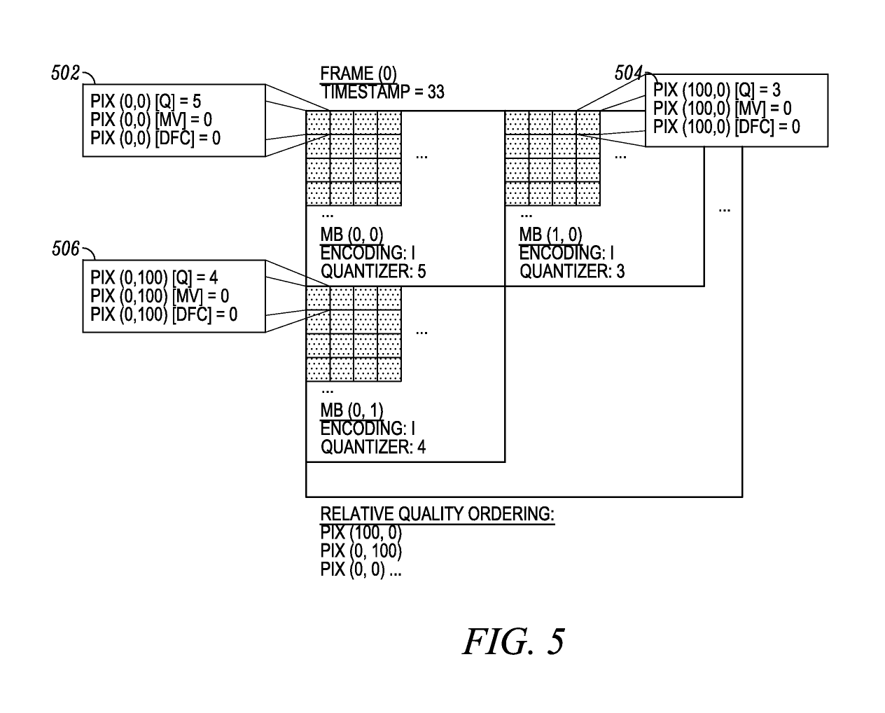

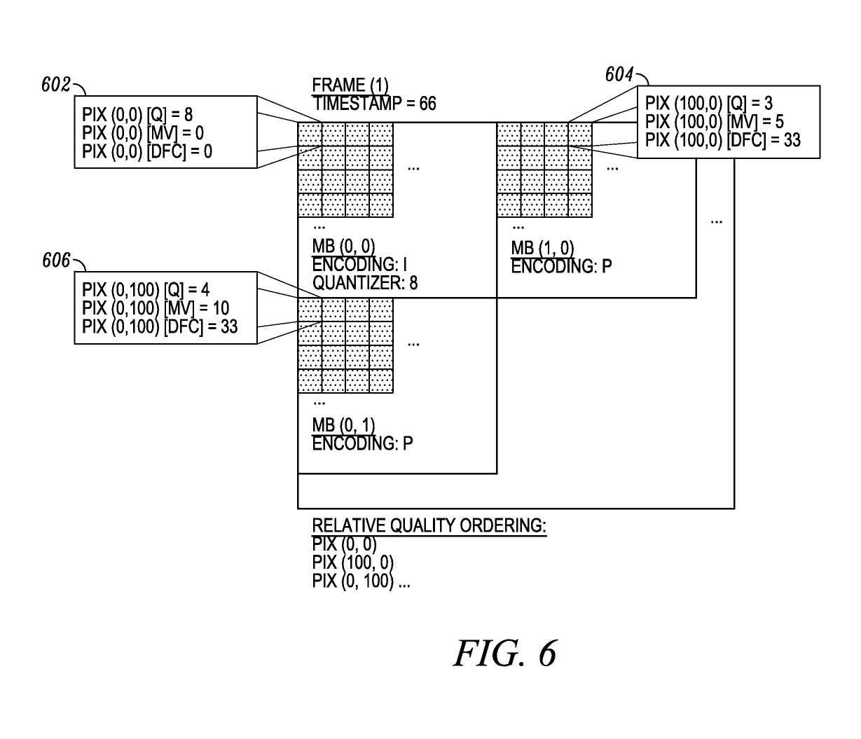

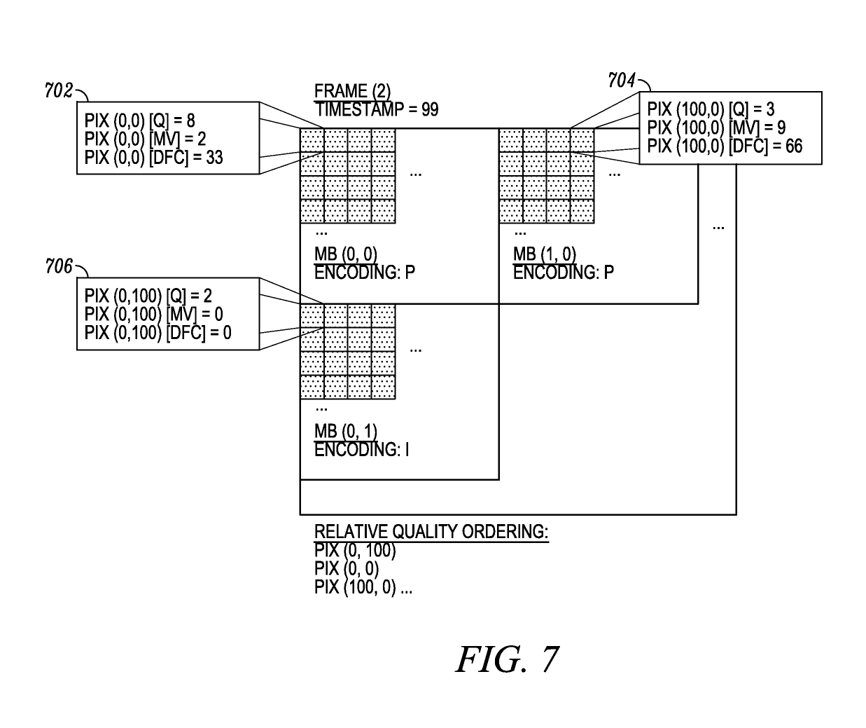

Thus, after a frame has been fully decoded, the decoder has generated a matrix of PIX(RA) accuracy values, one for each pixel. Lower values of PIX(RA) denote greater relative accuracy with respect to higher values of PIX(RA). FIGS. 5 to 7 show an implementation of the aforementioned illustrative algorithm to a sequence of frames: Frame (0) shown in FIG. 5; Frame (1) shown in FIG. 6; and Frame (2) shown in FIG. 7. Each respective figure shows the sets of values recorded over time, e.g., at frame timestamps 33, 66, and 99, for: pixel location (PIX) (0,0) in macroblock location (MB) (0,0) (e.g., 502, 602, 702); PIX (100,0) in MB (1,0) (e.g., 504, 604, 704); and PIX (0,100) in MB (0,1) (e.g., 506, 606, 706), upon which relative quality ranking are made.

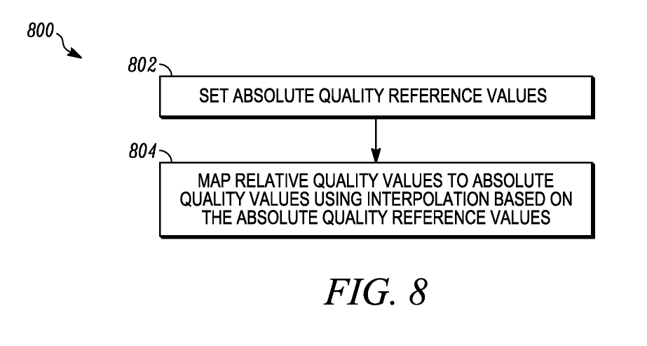

In a further embodiment, an absolute quality value is established based on the relative quality values. By way of illustration, FIG. 8 shows a method 800 for the decoder to determine absolute quality values for decompressed pixels. Generally, the decoder sets (802) a plurality of absolute quality reference values, which are, for example, determined a priori by a customer to match quality expectations for the particular mission of the video being encoded, and maps (804) the relative quality values to absolute quality values using interpolation, as necessary, based on the absolute quality reference values. For example, PIX[MV=100,Q=0,DFC=0] might be assigned an absolute quality value of 100, PIX[MV=5,Q=10,DFC=0] might be assigned an absolute quality value of 70, and PIX[MV=15,Q=31,DFC=5] might be assigned an absolute quality value of 0. Any given PIX(x,y)[MV,Q,DFC] can then be mapped to an absolute quality value PIX(x,y)[AA] through interpolation.

For recorded streams that will later be presented, for instance in a court of law, this matrix of relative PIX(x,y)[RA] and absolute PIX(x,y)[AA] quality values is written to a storage medium (e.g., a disk) alongside (or contemporaneously with) the visual data of the decompressed pixels. More particularly, the relative rankings, relative quality values, absolute quality values, or some combination thereof, (indexed by pixel ID, e.g., pixel (x,y) location) are correlated in time with the corresponding decompressed pixels (for example by the quality metadata and video streams being time stamped together), such that they can later be cross-referenced. Moreover, in an embodiment, the decoder performs a compression technique on the quality data such as by using a lossless technique (like RLE (run-length encoding)), since many grouped pixels would likely share the same value.

Changes could be made to the above-described algorithm without loss of generality. For example, temporal encoding can be applied using more than one reference frame and result in multiple motion vectors for a given pixel value. Additionally, motion vectors may be associated with smaller containers of a macroblock, like a block, for example. This algorithm can easily be expanded to accommodate such a scenario.

In addition, the quality metadata could be presented to an end user in a number of ways. In one embodiment, the quality values are correlated in time with the corresponding decompressed pixels, and a representation of the quality values is displayed with the corresponding decompressed pixels. For example, one embodiment would overlay this matrix of quality information, in real-time, over the corresponding decoded video image; and values of PIX(RA) or PIX(AA) could be assigned differing translucent colors, shades of a color, grayscale shading, cross-hashing levels of darkness, etc., in order to visually distinguish the quality levels as corresponds to the decompressed pixels. These visual representations are overlaid or mixed on top of the corresponding decompressed video image. Since pixels tend to be spatially encoded, moved together, or missing in groups (due to the use of macroblocks), large blocks of a given visual representation would typically be seen. Such a visual representation could, for example, aid officials performing tactual surveillance, such that in real-time they could quickly determine which portions of a given scene could be relied upon as accurate representations of the source video.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for determining the reproduction accuracy of decompressed video with respect to the corresponding source video described herein. The non-processor circuits may include, but are not limited to, a radio receiver, a radio transmitter, signal drivers, clock circuits, power source circuits, and user input devices. As such, these functions may be interpreted as steps of a method to perform the determining of reproduction accuracy of decompressed video with respect to the corresponding source video described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage element or medium having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for determining reproduction accuracy of decompressed video, the method comprising:
at a decoder:
receiving compressed video;
processing the video to generate decompressed video comprising a plurality of pixels in a sequence of frames;
for at least some of the pixels, determining, on a pixel by pixel basis, motion vector and quantizer values for the pixels and determining a quality value for each corresponding pixel using the motion vector and quantizer values, wherein the quality values provide a measure of reproduction accuracy of the decompressed video with respect to corresponding uncompressed video.

2. The method of claim 1, wherein the quality value determined for each pixel comprises at least one of a relative quality value or an absolute quality value.

3. The method of claim 2 further comprising correlating the quality values in time with the corresponding decompressed pixels.

4. The method of claim 3 further comprising displaying a representation of the quality values correlated in time with the corresponding decompressed pixels.

5. The method of claim 4, wherein the displaying comprises overlaying the representation of the quality values over the corresponding decompressed pixels.

6. The method of claim 5, wherein the representation visually distinguishes the relative quality values.

7. The method of claim 2 further comprising:
writing the quality values to a storage medium contemporaneously with the corresponding decompressed pixels; and
correlating the quality values in time with the corresponding decompressed pixels on the storage medium.

8. The method of claim 7 further comprising performing a compression technique on the quality values before writing them to the storage medium.

9. The method of claim 8, wherein the compression technique comprises a lossless compression technique.

10. The method of claim 1, wherein the quality values are relative quality values, and wherein determining the relative quality value for each corresponding pixel using the motion vector and quantizer values comprises:
determining whether the decompressed pixel was spatially encoded or temporally compensated;
upon determining that the decompressed pixel was spatially encoded, the method further comprising:
recording the quantizer value, which comprises a quantizer value for a macroblock that includes the pixel;
recording the motion vector value, which comprises a zero magnitude;
recording a delta frame count of a zero value since the pixel was last spatially encoded;
upon determining that the decompressed pixel was temporally compensated, the method further comprising:
recording the quantizer value, which comprises a quantizer value for the pixel when it was last spatially encoded;
recording the motion vector value, which comprises a non-zero magnitude;
recording a non-zero delta frame count value since the pixel was last spatially encoded; and
sorting the pixels based on the recorded quantizer values, motion vector values and delta frame counts, and assigning the relative quality values to the sorted pixels.

11. The method of claim 10, wherein upon determining that the decompressed pixel was temporally compensated, the method further comprising:
computing the motion vector value by summing all motion vector magnitudes used to encode the pixel since the pixel was last spatially encoded.

12. The method of claim 10, wherein the sorting comprises ranking the decompressed pixels and assigning the relative quality values based on the relative rankings.

13. The method of claim 11, wherein the ranking comprises:
performing a primary sort based on the recoded motion vector values;
performing a secondary sort based on the recorded quantizer values; and
performing a tertiary sort based on the recorded delta frame counts.

14. The method of claim 1, wherein the quality values are relative quality values, the method further comprising generating absolute quality values, for the corresponding decompressed pixels, from the relative quality values.

15. The method of claim 14, wherein generating the absolute quality values comprises:
setting a plurality of absolute quality reference values; and
mapping the relative quality value to the corresponding absolute quality value using interpolation based on the plurality of absolute quality reference values.

16. A computer-readable storage element having computer readable code stored thereon for programming a computer to perform a method for determining reproduction accuracy of decompressed video in a decoder upon receiving compressed video and processing the video to generate decompressed video comprising a plurality of pixels in a sequence of frames, the method comprising:
for at least some of the pixels, determining, on a pixel by pixel basis, motion vector and quantizer values for the pixels; and
determining a quality value for each corresponding pixel using the motion vector and quantizer values, wherein the quality values provide a measure of reproduction accuracy of the decompressed video with respect to corresponding uncompressed video.

17. A video decoder comprising:
an interface that receives compressed video; and
a processor that:
processes the video to generate decompressed video comprising a plurality of pixels in a sequence of frames; and
for at least some of the pixels, determines, on a pixel by pixel basis, motion vector and quantizer values for the pixels and determines a quality value for each corresponding pixel using the motion vector and quantizer values, wherein the quality values provide a measure of reproduction accuracy of the decompressed video with respect to corresponding uncompressed video.
